(19) United States
(12) Patent Application Publication
(10) Pub. No.: US 2023/0180199 A1
(43) Pub. Date: Jun. 8, 2023

(54) Method and Apparatus for the Selective Decoding of Physical Downlink Control Candidates Based on a Determined Frequency Location and Frequency Hopping

(71) Applicant: Lenovo (United States) Inc. a Corporation of Delaware, Morrisville, NC (US)

(72) Inventors: Hyejung Jung, Northbrook, IL (US); Vijay Nangia, Woodridge, IL (US); Ravi Kuchibhotla, Clarendon Hills, IL (US)

(21) Appl. No.: 17/924,677

(22) PCT Filed: May 14, 2021
(86) PCT No.: PCT/US21/32514

§ 371 Date: Nov. 10, 2022

Related U.S. Application Data
(60) Provisional application No. 63/025,093, filed on May 14, 2020.

(51) Int. Cl. H04W 72/0453; H04W 72/23; H04W 72/0457; H04L 1/00; H04L 5/00

(52) U.S. Cl. CPC H04W 72/0453; H04W 72/23; H04W 72/0457; H04L 1/0038; H04L 5/0012

(57) ABSTRACT

A method and apparatus are provided, in which information of a frequency domain resource of a control resource set of an active downlink bandwidth part and information of a search space set associated with the control resource set are received (302). A frequency location of the control resource set is determined (304) at a physical downlink control channel monitoring occasion of the search space set based on the information of the frequency domain resource and information of frequency hopping of the control resource set. Blind decoding of physical downlink control channel candidates is performed (306) based on the determined frequency location of the control resource set at the physical downlink control channel monitoring occasion.

### FIELD OF THE INVENTION

The present disclosure is directed to the selective decoding of physical downlink control channel candidates based on a determined frequency location of the control resource set and determined information of frequency hopping, including instances where the determined frequency location is associated with a particular active downlink bandwidth part.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Long Term Evolution (LTE), Universal Mobile Telecommunications Service (UMTS), Global System for Mobile Communication (GSM), and/or Enhanced Data GSM Environment (EDGE).

As part of communicating with the network, a user equipment does not always know when an incoming communication is going to be received from the network. Furthermore, always actively monitoring for an incoming communication by the user equipment can involve needing to maintain certain portions of the electronic circuitry in an active state, where larger amounts of power may be required by the corresponding circuitry to maintain the circuitry in the active state.

As a way to help conserve power, various forms of discontinuous reception modes have been implemented, which seek to limit the duration in which a user device needs to be actively monitoring for incoming communications. This can sometimes involve limiting the periods of time in which the user equipment is actively monitoring for incoming communication. These periods are often generally known to the network, so that attempts to contact the user equipment by the network can be limited to one of these previously determined windows of availability.

One of the challenges with managing the periods of availability in which the user equipment is monitoring for incoming communications, is that in some instances, any incoming communication may sometimes need to be delayed until an active window of monitoring for a particular user equipment becomes available. In some instances, the incoming communication could be associated with a requested scheduling grant related to the anticipated transmission to the network by the user equipment of data to be sent to the network, that may have different degrees of tolerance for any such delay.

For some types of devices, there may be an increased incentive for managing the available periods of time that a device is available for receiving an incoming communication, and correspondingly when a device is unavailable and may be able to place one or more portions of its electronic circuitry into an inactive state during which overall power consumption for the device can be reduced. One such type of device can include at least some forms of reduced capability user equipment, which can sometimes be intended to operate for extended periods of time unattended under a single charge. To the extent that overall power consumption can be further reduced, the device may be better able to operate under a single charge for an even larger extended period of time.

The present inventors have recognized that in addition to managing when and how often a device monitors a channel, it may be advantageous to manage how much of a channel to monitor and/or use, where the monitoring and/or use of a wider band, as opposed to the monitoring and/or use of a relatively narrower band, may also require the use of more resources and corresponding potentially larger amounts of power. By identifying a subset of a channel to use it may be possible to allow for a more power efficient operation. Further to the extent that a narrower band may be defined, the narrower band could potentially make use of frequency hopping within a particular bandwidth part, which may also help to avoid possible sources of interference.

### SUMMARY

The present application provides a method in a user equipment. The method includes receiving information of a frequency domain resource of a control resource set of an active downlink bandwidth part and information of a search space set associated with the control resource set. A frequency location of the control resource set is determined at a physical downlink control channel monitoring occasion of the search space set based on the information of the frequency domain resource and information of frequency hopping of the control resource set. Blind decoding of physical downlink control channel candidates is performed based on the determined frequency location of the control resource set at the physical downlink control channel monitoring occasion.

According to another possible embodiment, a user equipment for communicating within a network is provided. The user equipment includes a transceiver that receives information of a frequency domain resource of a control resource set of an active downlink bandwidth part and information of a search space set associated with the control resource set. The user equipment further includes a controller that determines a frequency location of the control resource set at a physical downlink control channel monitoring occasion of the search space set based on the information of the frequency domain resource and information of frequency hopping of the control resource set, and performs blind decoding of physical downlink control channel candidates based on the determined frequency location of the control resource set at the physical downlink control channel monitoring occasion.

According to a further possible embodiment, a method in a network entity for communicating with a user equipment is provided. The method includes transmitting information of a frequency domain resource of a control resource set of an active downlink bandwidth part and information of a search space set associated with the control resource set. A frequency location of the control resource set at a physical downlink control channel monitoring occasion of the search space set is determined, based on the information of the frequency domain resource and information of frequency hopping of the control resource set. A physical downlink control channel is transmitted, based on the determined frequency location of the control resource set at the physical downlink control channel monitoring occasion.

According to a still further possible embodiment, a network entity for communicating with a user equipment is provided. The network entity includes a transceiver that transmits information of a frequency domain resource of a control resource set of an active downlink bandwidth part and information of a search space set associated with the control resource set. The network entity further includes a controller that determines a frequency location of the control resource set at a physical downlink control channel monitoring occasion of the search space set based on the information of the frequency domain resource and information of frequency hopping of the control resource set. A physical downlink control channel is transmitted based on the determined frequency location of the control resource set at the physical downlink control channel monitoring occasion.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is a resource map illustrating an example of control resource set frequency hopping;

FIG. 3 is a flow diagram in a user equipment associated with the selective decoding of physical downlink control channel candidates based on a determined frequency location of the control resource set and determined information of frequency hopping;

FIG. 4 is a flow diagram in a network entity associated with the selective transmission of physical downlink control channel candidates based on a determined frequency location of the control resource set and determined information of frequency hopping; and

FIG. 5 is an exemplary block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide more power efficient operation in reduced capability user equipment.

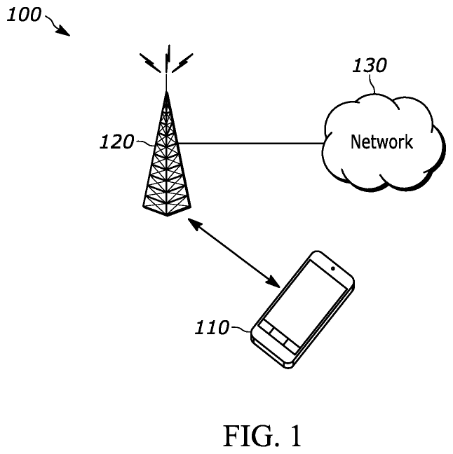

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130. The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In RAN #86, New study item (SID) on support of reduced capability NR devices (RP-193238) was approved. The requirements and target use cases are listed below:

Generic Requirements:
Device complexity: Main motivation for the new device type is to lower the device cost and complexity as compared to high-end enhanced mobile broadband (eMBB) and ultra-reliable low-latency communication (URLLC) devices of Rel-15/Rel-16. This is especially the case for industrial sensors.
Device size: Requirement for most use cases is that the standard enables a device design with compact form factor.
Deployment scenarios: System should support all frequency range 1 (FR1)/frequency range 2 (FR2) bands for frequency division duplex (FDD) and time division duplex (TDD).

Use Case Specific Requirements:
Industrial wireless sensors: reference use cases and requirements are described in 3GPP technical report (TR) 22.832, entitled technical specification group services and system aspects, study on enhancements for cyber-physical control applications in vertical domains, and TS 22.104, entitled technical specification group services and system aspects, service requirements for cyber-physical control applications in vertical domains: communication service availability is 99.99% and end-to-end latency less than 100 ms. The reference bit rate is less than 2 Mbps (potentially asymmetric e.g. uplink (UL) heavy traffic) for all use cases and the device is stationary. The battery should last at least few years. For safety related sensors, latency requirement is lower, 5-10 ms (TR 22.804),
Video Surveillance: As described in TS 22.804, reference economic video bitrate would be 2-4 Mbps, latency <500 ms, reliability 99%-99.9%. High-end video e.g. for farming would require 7.5-25 Mbps. It is noted that traffic pattern is dominated by UL transmissions.
Wearables: Reference bitrate for smart wearable application can be 10-50 Mbps for downlink (DL) and minimum 5 Mbps in UL and peak bit rate of the device higher, such as 150 Mbps for downlink and 50 Mbps for uplink. The battery of the device should last multiple days (up to 1-2 weeks). The intention is to study a UE feature and parameter list with lower end capabilities, relative to Release 16 eMBB and URLLC NR to serve the three use cases mentioned above.

The Study Item Includes the Following Objectives:
Identify and study potential UE complexity reduction features, including [radio access network 1 (RAN1), radio access network 2 (RAN2)]:
   Reduced number of UE receive (RX)/transmit (TX) antennas
   UE Bandwidth reduction
   Note: Rel-15 synchronization signal block (SSB) bandwidth should be reused and layer 1 (L1) changes minimized
   Half-Duplex-FDD
   Relaxed UE processing time
   Relaxed UE processing capability
Note1: The work defined above should not overlap with low power wide area (LPWA) use cases. The lowest capability considered should be no less than an LTE Category 1bis modem.
Study UE power saving and battery lifetime enhancement for reduced capability UEs in applicable use cases (e.g. delay tolerant) [RAN2, RAN1]:
   Reduced physical downlink control channel (PDCCH) monitoring by smaller numbers of blind decodes and control channel element (CCE) limits [RAN1].
   Extended discontinuous reception (DRX) for radio resource control (RRC) Inactive and/or Idle [RAN2]
   radio resource management (RRM) relaxation for stationary devices [RAN2]
Study functionality that will enable the performance degradation of such complexity reduction to be mitigated or limited, including [RAN1]:
   Coverage recovery to compensate for potential coverage reduction due to the device complexity reduction.
Study standardization framework and principles for how to define and constrain such reduced capabilities—considering definition of a limited set of one or more device types and considering how to ensure those device types are only used for the intended use cases [RAN2, RAN1].
Study functionality that will allow devices with reduced capabilities to be explicitly identifiable to networks and network operators, and allow operators to restrict their access, if desired [RAN2, RAN1].
Note2: Potential overlap with coverage enhancements study is discussed and resolved in RAN #87.
Note3: Coexistence with Rel-15 and Rel-16 UE should be ensured
Note4: This SI should focus on SA mode and single connectivity

Reduced capability UEs such as industrial wireless sensors, video surveillance, and wearables may need to be operated with the battery that should last from multiple days (e.g. wearables) to at least few years (e.g. industrial sensors). Operating a reduced capability UE with a narrow bandwidth by configuring and activating a narrowband bandwidth part may reduce power consumption and accordingly, may lead to power saving for the reduced capability UE. On the other hand, the narrowband bandwidth part may make it difficult to exploit frequency diversity and realize interference randomization, unless the reduced capability UE is configured with multiple narrowband bandwidth parts, each with PDCCH configuration, and performs frequent switching of an active bandwidth part (BWP).

The present filing presents methods to allow power-efficient PDDCH monitoring and yet to effectively exploit frequency diversity without increasing signaling overhead.

In accordance with 3GPP Technical Specification 38.211 (V16.1.0) 7.3.2.2 Control-resource set (CORESET)

A control-resource set consists of N_{RB}^{CORESET} resource blocks in the frequency domain and N_{symb}^{CORESET} ∈{1,2,3} symbols in the time domain.

A control-channel element consists of 6 resource-element groups (REGs) where a resource-element group equals one resource block during one orthogonal frequency division multiplexing (OFDM) symbol. Resource-element groups within a control-resource set are numbered in increasing order in a time-first manner, starting with 0 for the first OFDM symbol and the lowest-numbered resource block in the control resource set.

A UE can be configured with multiple control-resource sets. Each control-resource set is associated with one CCE-to-REG mapping only.

The CCE-to-REG mapping for a control-resource set can be interleaved or non-interleaved and is described by REG bundles:
REG bundle i is defined as REGs {iL, iL+1, . . . , iL+L−1} where L is the REG bundle size, i=0, 1, . . . , N_{REG}^{CORESET}/L−1, and N_{REG}^{CORESET}=N_{RB}^{CORESET}N_{Symb}^{CORESET} is the number of REGs in the CORESET
CCE j consists of REG bundles {f(6j/L), f(6j/L+1), . . . , f(6j/L+6/L−1)} where f(⋅) is an interleaver
   For non-interleaved CCE-to-REG mapping, L=6 and f(x)=x.
   For interleaved CCE-to-REG mapping, L∈{2,6} for N_{symb}^{CORESET}=1 and L∈{N_{symb}^{CORESET},6} for N_{symb}^{CORESET} ∈{2,3}. The interleaver is defined by

f(x)=(rC+c+n_{shift})mod(N_{REG}^{CORESET}/L)

x=cR+r

r=0,1, . . . ,R−1

c=0,1, . . . ,C−1

C=N_{REG}^{CORESET}/(LR)

where R∈{2,3,6}.

The UE is not expected to handle configurations resulting in the quantity C not being an integer.

For a CORESET configured by the ControlResourceSet information element (IE):
N_{RB}^{CORESET} is given by the higher-layer parameter frequencyDomainResources;
N_{symb}^{CORESET} is given by the higher-layer parameter duration, where N_{symb}^{CORESET}=3 is supported only if the higher-layer parameter dmrs-TypeA-Position equals 3;
interleaved or non-interleaved mapping is given by the higher-layer parameter cce-REG-MappingType;
L equals 6 for non-interleaved mapping and is given by by the higher-layer parameter reg-BundleSize for interleaved mapping;
R is given by the higher-layer parameter interleaverSize;
n_{shift} ∈{0, 1, . . . ,274} is given by the higher-layer parameter shiftIndex if provided, otherwise n_{shift}=N_{ID}^{cell};
for both interleaved and non-interleaved mapping, the UE may assume
   the same precoding being used within a REG bundle if the higher-layer parameter precoderGranularity equals sameAsREG-bundle;
   the same precoding being used across the all resource-element groups within the set of contiguous resource blocks in the CORESET, and that no resource elements in the CORESET overlap with an SSB or LTE cell-specific reference signals as indicated by the higher-layer parameter lte-CRS-ToMatchAround or additionalLTE-CRS-ToMatchAroundList, if the higher-layer parameter precoderGranularity equals allContiguousRBs.
      For CORESET 0 configured by the ControlResourceSetZero IE:
N_{RB}^{CORESET} and N_{symb}^{CORESET} are defined by clause 13 of [5, TS 38.213];
the UE may assume interleaved mapping
L=6;
R=2;
n_{shift}=N_{ID}^{cell};
the UE may assume normal cyclic prefix when CORESET 0 is configured by MIB or SIB1;
the UE may assume the same precoding being used within a REG bundle.

In accordance with 3GPP Technical Specification 38.213 (V16.1.0)

### 10.1 UE Procedure for Determining Physical Downlink Control Channel Assignment

### Text Omitted

For each CORESET, the UE is provided the following by ControlResourceSet:
a CORESET index p, by controlResourceSetId, where
   0≤p<12 if CORESETPoolIndex is not provided, or if a value of CORESETPoolIndex is same for all CORESETs if CORESETPoolIndex is provided;
   0<p<16 if CORESETPoolIndex is not provided for a first CORESET, or is provided and has a value 0 for a first CORESET, and is provided and has a value 1 for a second CORESET;
a demodulation reference signal (DM-RS) scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception in a respective CORESET;
   if the UE is provided by simultaneousTCI-CellList a number of lists of cells for simultaneous transmission configuration indicator (TCI) state activation, the UE applies the antenna port quasi co-location provided by TCI-States with same activated tci-StateID value to CORESETs with index p in all configured DL BWPs of all configured cells in a list determined from a serving cell index provided by a medium access control (MAC) CE command
an indication for a presence or absence of a transmission configuration indicator (TCI) field for a DCI format, other than downlink control information (DCI) format 1_0, that schedules physical downlink shared channel (PDSCH) receptions or indicates semi-persistent scheduling (SPS) PDSCH release and is transmitted by a PDCCH in control resource set (CORESET) p, by tci-PresentInDCI or tci-PresentInDCI-ForDCIFormat1_2.
   When precoderGranularity=allContiguousRBs, a UE does not expect
to be configured a set of resource blocks of a CORESET that includes more than four sub-sets of resource blocks that are not contiguous in frequency
any resource element (RE) of a CORESET to overlap with any RE determined from lte-CRS-ToMatchAround, or from LTE-CRS-PatternList-r16, or with any RE of a synchronization signal/physical broadcast channel (SS/PBCH) block.
   For each CORESET in a DL BWP of a serving cell, a respective frequencyDomainResources provides a bitmap.
if a CORESET is not associated with any search space set configured with freqMonitorLocation-r16, the bits of the bitmap have a one-to-one mapping with non-overlapping groups of 6 consecutive PRBs, in ascending order of the physical resource block (PRB) index in the DL BWP bandwidth of N_{RB}^{BWP} PRBs with starting common RB position N_{BWP}^{start}, where the first common RB of the first group of 6 PRBs has common RB index 6·┌N_{BWP}^{start}/6┐ if rb-offset is not provided, or the first common RB of the first group of 6 PRBs has common RB index N_{BWP}^{start}+N_{RB}^{offset} where N_{RB}^{offset} is provided by rb-offset.
if a CORESET is associated with at least one search space set configured with freqMonitorLocation-r16, the first N_{RBG,set0}^{size} bits of the bitmap have a one-to-one mapping with non-overlapping groups of 6 consecutive PRBs, in ascending order of the PRB index in the DL BWP bandwidth of N_{RB}^{BWP} PRBs with starting common RB position N_{BWP}^{start}, where the first common RB of the first group of 6 PRBs has common RB index N_{BWP}^{start}+N_{RB}^{offset}. N_{RBG,set0}^{size}=└(N_{RB,set0}^{size}−NRBoffset)/6, NRB,set0size is a number of available PRBs in the RB set 0 for the DL BWP, and N_{RB}^{offset} is provided by rb-offset or N_{RB}^{offset}=0 if rb-offset is not provided.
   For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a medium access control (MAC) CE activation command for one of the TCI states as described in [11, TS 38.321], the UE assumes that the DM-RS antenna port associated with PDCCH receptions is quasi co-located with the SS/physical broadcast channel (PBCH) block the UE identified during the initial access procedure;
if a UE has been provided a configuration of more than one TCI states by tci-StatesPDCCH-ToAddList and tci-StatesPDCCH-ToReleaseList for the CORESET as part of Reconfiguration with sync procedure as described in [12, TS 38.331] but has not received a MAC CE activation command for one of the TCI states as described in [11, TS 38.321], the UE assumes that the DM-RS antenna port associated with PDCCH receptions is quasi co-located with the SS/PBCH block or the channel state information-reference signal (CSI-RS) resource the UE identified during the random access procedure initiated by the Reconfiguration with sync procedure as described in [12, TS 38.331].
   For a CORESET with index 0, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure.
   For a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that quasi co-located (QCL)-TypeD of a CSI-RS in a TCI state indicated by a MAC CE activation command for the CORESET is provided by a SS/PBCH block
if the UE receives a MAC CE activation command for one of the TCI states, the UE applies the activation command in the first slot that is after slot k+3·Nₛₗₒₜ^{subframe,μ} where k is the slot where the UE would transmit a physical uplink control channel (PUCCH) with hybrid automatic repeat request-acknowledgement (HARQ-ACK) information for the PDSCH providing the activation command and μ is the SCS configuration for the PUCCH. The active BWP is defined as the active BWP in the slot when the activation command is applied.
   For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId
a PDCCH monitoring periodicity of kₛ slots and a PDCCH monitoring offset of oₛ slots, by monitoringSlotPeriodicityAndOffset
a PDCCH monitoring pattern within a slot, indicating first symbol(s) of the CORESET within a slot for PDCCH monitoring, by monitoringSymbolsWithinSlot
a duration of Tₛ<kₛ slots indicating a number of slots that the search space set s exists by duration
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a common search space (CSS) set or a UE specific search space (USS) set by searchSpaceType
if search space set s is a CSS set
   an indication by dci-Format0-0-AndFormat1-0 to monitor PDCCH candidates for downlink control information (DCI) format 0_0 and DCI format 1_0
   an indication by dci-Format2-0 to monitor one or two PDCCH candidates for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
an indication by dci-Format2-4 to monitor PDCCH candidates for DCI format 2_4
an indication by dci-Format2-6 to monitor PDCCH candidates for DCI format 2_6
if search space set s is a USS set, an indication by dci-Formats to monitor PDCCH candidates either for DCI format 0_0 and DCI format 1_0, or for DCI format 0_1 and DCI format 1_1, or an indication by dci-Formats-Rel16 to monitor PDCCH candidates for DCI format 0_0 and DCI format 1_0, or for DCI format 0_1 and DCI format 1_1, or for DCI format 0_2 and DCI format 1_2, or, if a UE indicates a corresponding capability, for DCI format 0_1, DCI format 1_1, DCI format 0_2, and DCI format 1_2, or for DCI format 3_0, or for DCI format 3_1, or for DCI format 3_0 and DCI format 3_1
a bitmap by freqMonitorLocation-r16, if provided, to indicate one or more RB sets for the search space set s, where the MSB k in the bitmap corresponds to RB set k−1 in the DL BWP. For RB set k indicated in the bitmap, the first PRB of the frequency domain monitoring location confined within the RB set is given by N_{RB,set k}^{start}+N_{RB}^{offset}, where N_{RB,set k}^{start} is the index of first PRB of the RB set k, and N_{RB}^{offset} is provided by rb-offset or N_{RB}^{offset}=0 if rb-offset is not provided. The frequency domain resource allocation pattern for each monitoring location is determined based on the first N_{RBG,set 0}^{size} bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} [4, TS 38.211] in a frame with number n_{f} if (n₁ Nₛₗₒₜ^{frame, μ}+n_{s,f}^{μ}−oₛ)mod kₛ=0. The UE monitors PDCCH candidates for search space set s for r consecutive slots, starting from slot n_{s,f}^{μ}, and does not monitor PDCCH candidates for search space set s for the next kₛ−Tₛ consecutive slots.

### Text Omitted

A UE expects to monitor PDCCH candidates for up to 4 sizes of DCI formats that include up to 3 sizes of DCI formats with cyclic redundancy check (CRC) scrambled by cell radio network temporary identifier (C-RNTI) per serving cell. The UE counts a number of sizes for DCI formats per serving cell based on a number of configured PDCCH candidates in respective search space sets for the corresponding active DL BWP.

### Text Omitted

CCEs for PDCCH candidates are non-overlapped if they correspond to
different CORESET indexes, or
different first symbols for the reception of the respective PDCCH candidates.

### Text Omitted

If a UE is provided resourceBlocks and symbolsInResourceBlock in RateMatchPattern, or if the UE is additionally provided periodicityAndPattern in RateMatchPattern, the UE can determine a set of RBs in symbols of a slot that are not available for PDSCH reception as described in [6, TS 38.214]. If a PDCCH candidate in a slot is mapped to one or more REs that overlap with REs of any RB in the set of RBs in symbols of the slot, the UE does not expect to monitor the PDCCH candidate.

### 12 Bandwidth Part Operation

### Text Omitted

A UE configured for operation in bandwidth parts (BWPs) of a serving cell, is configured by higher layers for the serving cell a set of at most four bandwidth parts (BWPs) for receptions by the UE (DL BWP set) in a DL bandwidth by parameter BWP Downlink or by parameter initialDownlinkBWP with a set of parameters configured by BWP-DownlinkCommon and BWP-DownlinkDedicated, and a set of at most four BWPs for transmissions by the UE (UL BWP set) in an UL bandwidth by parameter BWP-Uplink or by parameter initialUplinkBWP with a set of parameters configured by BWP-UplinkCommon and BWP-UplinkDedicated.

If a UE is not provided initialDownlinkBWP, an initial DL BWP is defined by a location and number of contiguous PRBs, starting from a PRB with the lowest index and ending at a PRB with the highest index among PRBs of a CORESET for Type0-PDCCH CSS set, and a SCS and a cyclic prefix for PDCCH reception in the CORESET for Type0-PDCCH CSS set; otherwise, the initial DL BWP is provided by initialDownlinkBWP. For operation on the primary cell or on a secondary cell, a UE is provided an initial UL BWP by initialUplinkBWP. If the UE is configured with a supplementary UL carrier, the UE can be provided an initial UL BWP on the supplementary UL carrier by initialUplinkBWP.

If a UE has dedicated BWP configuration, the UE can be provided by firstActiveDownhnkBWP-Id a first active DL BWP for receptions and by firstActiveUplinkBWP-Id a first active UL BWP for transmissions on a carrier of the primary cell.

For each DL BWP or UL BWP in a set of DL BWPs or UL BWPs, respectively, the UE is provided the following parameters for the serving cell as defined in [4, TS 38.211] or [6, TS 38.214]:
a SCS by subcarrierSpacing
a cyclic prefix by cyclicPrefix
a common RB N_{BWP}^{start}=O_{carrier}+RBₛₜₐᵣₜ and a number of contiguous RBs N_{BWP}^{size}=L_{RB} provided by locationAndBandwidth that indicates an offset RBₛₜₐᵣₜ and a length L_{RB} as RIV according to [6, TS 38.214], setting N_{BWP}^{size}=275, and a value O_{carrier} provided by offsetToCarrier for the subcarrierSpacing
an index in the set of DL BWPs or UL BWPs by respective BWP-Id
a set of BWP-common and a set of BWP-dedicated parameters by BWP-DownlinkCommon and BWP-DownlinkDedicated for the DL BWP, or BWP-UplinkCommon and BWP-UplinkDedicated for the UL BWP [12, TS 38.331]

For unpaired spectrum operation, a DL BWP from the set of configured DL BWPs with index provided by BWP-Id is linked with an UL BWP from the set of configured UL BWPs with index provided by BWP-Id when the DL BWP index and the UL BWP index are same. For unpaired spectrum operation, a UE does not expect to receive a configuration where the center frequency for a DL BWP is different than the center frequency for an UL BWP when the BWP-Id of the DL BWP is same as the BWP-Id of the UL BWP.

For each DL BWP in a set of DL BWPs of the primary cell (PCell), or of the PUCCH-secondary cell (SCell), a UE can be configured CORESETs for every type of CSS sets and for USS as described in Clause 10.1. The UE does not expect to be configured without a CSS set on the PCell, or on the PUCCH-SCell, of the master cell group (MCG) in the active DL BWP.

If a UE is provided controlResourceSetZero and searchSpaceZero in PDCCH-ConfigSIB1 or PDCCH-ConfigCommon, the UE determines a CORESET for a search space set from controlResourcesetZero as described in Clause 13 and for Tables 13-1 through 13-10, and determines corresponding PDCCH monitoring occasions as described in Clause 13 and for Tables 13-11 through 13-15. If the active DL BWP is not the initial DL BWP, the UE determines PDCCH monitoring occasions for the search space set only if the CORESET bandwidth is within the active DL BWP and the active DL BWP has same SCS configuration and same cyclic prefix as the initial DL BWP.

### Text Omitted

In accordance with 3GPP Technical Specification 38.133 (V15) 8.6.2 DCI and timer based BWP switch delay

The requirements in this clause only apply to the case that the BWP switch is performed on a single component carrier (CC).

For DCI-based BWP switch, after the UE receives BWP switching request at DL slot n on a serving cell, UE shall be able to receive PDSCH (for DL active BWP switch) or transmit physical uplink shared channel (PUSCH) (for UL active BWP switch) on the new BWP on the serving cell on which BWP switch on the first DL or UL slot occurs right after the beginning of DL slot n+T_{BWPswitchDelay}.

The UE is not required to transmit UL signals or receive DL signals during time duration T_{BWPswitchDelay} on the cell where DCI-based BWP switch occurs. The UE is not required to follow the requirements defined in this clause when performing a DCI-based BWP switch between the BWPs in disjoint channel bandwidths or in partially overlapping channel bandwidths.

For timer-based BWP switch, the UE shall start BWP switch at DL slot n, where n is the beginning of a DL subframe (FR1) or DL half-subframe (FR2) immediately after a BWP-inactivity timer bwp-InactivityTimer [2] expires on a serving cell, and the UE shall be able to receive PDSCH (for DL active BWP switch) or transmit PUSCH (for UL active BWP switch) on the new BWP on the serving cell on which BWP switch on the first DL or UL slot occurs right after the beginning of DL slot n+T_{BWPswitchDelay}.

The UE is not required to transmit UL signals or receive DL signals after bwp-InactivityTimer [2] expires on the cell where timer-based BWP switch occurs.

Depending on UE capability bwp-SwitchingDelay [2], UE shall finish BWP switch within the time duration T_{BWPswitchDelay} defined in Table 8.6.2-1.

TABLE 8.6.2-1
BWP switch delay

| | NR | BWP switch | |
|---|---|---|---|
| | Slot | delay T_{BWPswitchDelay} | |
| | length | (slots) | |
| μ | (ms) | Type 1^{Note1} | Type 2^{Note1} |
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
^{Note 2}:
If the BWP switch involves changing of SCS, the BWP switch delay is determined by the smaller SCS between the SCS before BWP switch and the SCS after BWP switch.

Provided the UE does not have the required TCI-state information to receive PDCCH and PDSCH in the new BWP, the UE shall use old TCI-states before the BWP switch until a new MAC CE updating the required TCI-state information for PDCCH and PDSCH is received after the BWP switch.

If UE has the information on the required TCI-state information to receive PDCCH and PDSCH in the new BWP,
UE shall be able to receive PDCCH and PDSCH with old TCI-states before the delay as specified in Clause 8.10 in the new BWP.
UE shall be able to receive PDCCH and PDSCH with new TCI-states after the delay as specified in Clause 8.10 in the new BWP.

### End of Included Section

In accordance with the present filing, in one implementation, a cell serving reduced capability UEs configures a bandwidth of a CORESET with an index zero (i.e. CORESET0, a CORESET for an associated Type0-PDCCH common search space (CSS) for a DCI format with cyclic redundancy check (CRC) scrambled by a system information radio network temporary identifier (SI-RNTI) on the primary cell of the master cell group (MCG)) to be equal to or less than a minimum UE bandwidth of the reduced capability UEs for a given frequency band (e.g., a smallest UE bandwidth that is supported on a given frequency band for UEs that are permitted to camp/not barred on a serving cell in the given frequency band). That is, the reduced capability UEs do not expect that the bandwidth of CORESET0 is larger than the predefined minimum UE bandwidth for them.

In another implementation, a cell serving reduced capability UEs in addition to Rel-15/16 NR UEs may configure a bandwidth of the CORESET0 larger than the minimum UE bandwidth of the reduced capability UEs. In this case, the cell may provide a separate CORESET0 of a separate Type0-PDCCH CSS for the reduced capability UEs. The reduced capability UEs may initiate identifying configuration information of the separate CORESET0 and the corresponding separate Type0-PDCCH CSS intended for the reduced capability UEs, once determining that a bandwidth of a legacy (e.g. NR Rel-15/16) CORESET0 of a legacy Type0-PDCCH CSS set configured by pdcch-ConfigSIB1 in MIB or by searchSpaceSIB1 in PDCCH-ConfigCommon or by searchSpaceZero in PDCCH-ConfigCommon is wider than the minimum UE bandwidth of the reduced capability UEs for the given frequency band.

In one implementation, a reduced capability UE may not support dynamic switching of an active bandwidth part based on indication of DCI and/or may only be configured with one UE-specific bandwidth part. In another implementation, the reduced capability UE may support DCI based (and/or timer based) dynamic switching of the active bandwidth part, potentially with relaxed bandwidth part switching delay requirements compared to NR UEs supporting eMBB and URLLC use cases. Considering that a bandwidth part configuration includes a set of DL and UL RRC configuration parameters such as PDCCH, PDSCH, PUCCH, and PUSCH configurations, it may be preferred to allow a reduced capability UE to be configured with a limited number of bandwidth parts (e.g. one UE-specific DL/UL bandwidth part and an initial DL/UL bandwidth part) for complexity reduction (e.g. memory capacity). In one example, a reduced capability UE may be configured with a first bandwidth part and a second bandwidth part, with at least one of a set of DL and UL RRC configuration parameters such as PDCCH, PDSCH, physical uplink control channel (PUCCH), and physical uplink shared channel (PUSCH) configurations configured on the first bandwidth part (e.g., BWP ID 1) and not on the second bandwidth part (e.g., BWP ID 2) with the UE assuming the at least one configuration is the same on the second bandwidth part as that on the first bandwidth part. The bandwidth parts use the same numerology for all the configured BWPs.

### Frequency Hopping of a CORESET

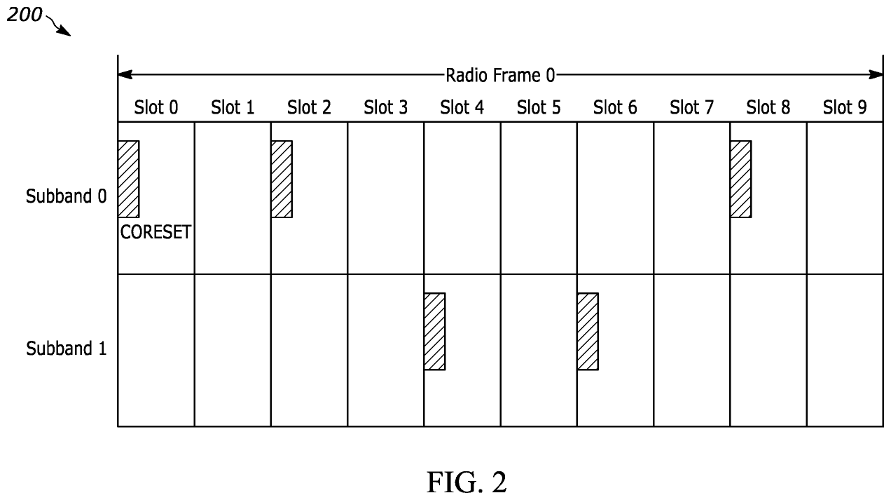

In one embodiment, a UE (potentially a reduced capability UE) receives information of a frequency domain resource of a control resource set of a DL active bandwidth part and information of frequency hopping (e.g. one or more frequency offset values and/or frequency hopping periodicity and/or frequency hopping pattern) of the control resource set within the DL active bandwidth part, determines a frequency location (e.g., set of PRBs) of the control resource set in each PDCCH monitoring occasion associated with the control resource set based on the information of the frequency domain resource and the information of frequency hopping, and performs blind decoding of PDCCH on the determined frequency location of the control resource set. Further, the UE determines a DL subband of the DL active bandwidth part associated with the determined frequency location of the control resource set, and receives DL signal/channels within the DL subband. The DL subband includes at least the frequency location of the control resource set. In one implementation, if the UE is configured with a PDCCH monitoring periodicity of kₛ slots and a PDCCH monitoring offset of oₛ slots, by the RRC parameter monitoringSlotPeriodicityAndOffset, the starting RB of the control resource set during the monitoring slot n_{s,f}^{μ} satisfying (n_{f}·Nₛₗₒₜ^{frame,μ}+n_{s,f}μ−oₛ) mod kₛ=0 is given by:

$$R {B}_{start} ( {n}_{s , f}^{μ} ) = \{ \begin{matrix}R {B}_{start} & ⌊ ( {n}_{f} \cdot {N}_{slot}^{frame , μ} + {n}_{s , f}^{μ} - {O}_{s} ) / {k}_{s}^{′} ⌋ mod 2 = 0 \\ ( R {B}_{start} + R {B}_{offset} ) mod {N}_{BWP}^{size} & ⌊ ( {n}_{f} \cdot {N}_{slot}^{frame , μ} + {n}_{s , f}^{μ} - {O}_{s} ) / {k}_{s}^{′} ⌋ mod 2 = 1\end{matrix} ,$$

where n_{s,f}^{μ} is a slot number within a radio frame n_{f}, kₛ′ is a CORESET frequency hopping periodicity in terms of a number of slots and is a multiple of the PDCCH monitoring periodicity kₛ, RBₛₜₐᵣₜ is the starting RB of the CORESET within the DL BWP calculated from the RRC parameter frequencyDomainResources of the CORESET configuration, and RB_{offset} is the frequency offset in RBs between the two frequency hops. In one example, the RB_{offset} is indicated by higher layer signaling, e.g. RRC signaling. In one example, the RB_{offset} is based on the number of RBs in active DL bandwidth part and/or the number of RBs comprising the CORESET. While monitoring PDCCH candidates for search space set s for Tₛ consecutive slots, starting from slot n_{s,f}^{μ}, the starting RB of the CORESET is same for the r consecutive slots. FIG. 2 is a resource map 200 illustrating an example of control resource set frequency hopping. More specifically, FIG. 2 illustrates an example of CORESET frequency hopping (PDCCH monitoring periodicity kₛ=2, PDCCH monitoring offset oₛ=0, the number of consecutive monitoring slots Tₛ=1, and CORESET frequency hopping periodicity kₛ′=4).

In another implementation, if the UE is configured with a PDCCH monitoring periodicity of kₛ slots and a PDCCH monitoring offset of oₛ slots, by the RRC parameter monitoringSlotPeriodicityAndOffset, the starting RB of the control resource set during the monitoring slot n_{s,f}^{μ} satisfying (n_{f}·Nₛₗₒₜ^{frame,μ}+n_{s,f}μ−Oₛ) mod kₛ=0 is given by:

$$R {B}_{start} ( {n}_{s , f}^{μ} ) = \{ \begin{matrix}R {B}_{start} , & if ⌊ ( {n}_{f} \cdot {N}_{slot}^{frame , μ} + {n}_{s , f}^{μ} - {O}_{s} ) / {k}_{s}^{′} ⌋ mod 3 = 0 \\ ( R {B}_{start} + R {B}_{offset , 1} ) mod {N}_{BWP}^{size} , & if ⌊ ( {n}_{f} \cdot {N}_{slot}^{frame , μ} + {n}_{s , f}^{μ} - {O}_{s} ) / {k}_{s}^{′} ⌋ mod 3 = 1 \\ ( R {B}_{start} + R {B}_{offset , 2} ) mod {N}_{BWP}^{size} , & if ⌊ ( {n}_{f} \cdot {N}_{slot}^{frame , μ} + {n}_{s , f}^{μ} - {O}_{s} ) / {k}_{s}^{′} ⌋ mod 3 = 2\end{matrix} ,$$

where n_{s,f}^{μ} is a slot number within a radio frame n_{f}, kₛ′ is a CORESET frequency hopping periodicity in terms of a number of slots and is a multiple of the PDCCH monitoring periodicity kₛ, RBₛₜₐᵣₜ is the starting RB within the UL BWP calculated from the RRC parameter frequencyDomainResources of the CORESET configuration, and RB_{offset,1} is a first frequency offset value in RBs and RB_{offset,2} is a second frequency offset value in RBs among the three frequency hops. In one example, the RB_{offset,1} and RB_{offset,2} are indicated by higher layer signaling, e.g. RRC signaling. While monitoring PDCCH candidates for search space set s for r consecutive slots, starting from slot n_{s,f}^{μ}, the starting RB of the CORESET is same for the Tₛ consecutive slots.

In one implementation, the UE is not expected to receive any DL signal/channel for a first duration right before a start of the first monitoring occasion within the CORESET frequency hopping periodicity for each frequency hop. The first duration may be represented in terms of a number of symbols or a number of slots, and may be configured or predefined and may be dependent of the numerology (e.g., subcarrier spacing) of the active DL BWP.

In another embodiment, a UE is configured with a plurality of CORESETs and a plurality of subbands within an active DL bandwidth part, each subband associated with a CORESET of the plurality of CORESETs, and performs subband switching among the plurality of subbands based on a predefined or configured subband switching pattern. The UE is not expected to receive any DL signal/channel for a first duration right before a start of a switched subband.

In other embodiments, a UE is configured with a plurality of DL bandwidth parts and performs BWP switching among the plurality of DL BWPs based on a predefined or configured BWP switching pattern.

Opportunistic Wideband Operation within a Bandwidth Part

A UE monitoring a narrowband CORESET and being operated within a DL/UL subband associated with a frequency location of the narrowband CORESET may continue being operated with a narrow bandwidth until the UE detects a DCI format indicating a wideband DL/UL signals/channels and/or is supposed to receive/transmit a semi-statically configured wideband DL/UL signals/channel. Once the UE starts to be operated with a wide bandwidth within the active DL/UL bandwidth part, the UE starts/re-starts a wideband operation timer at every reception or transmission occasion of wideband signals/channels.

In one embodiment, a reduced capability UE monitoring a PDCCH in a control resource set of a DL active bandwidth part is expected to receive a corresponding PDSCH and/or to transmit a corresponding uplink channel (e.g. PUSCH and PUCCH) confined within a first DL/UL subband of a first DL/UL bandwidth, where the first DL subband includes the control resource set and where the first DL/UL bandwidth is narrower than a bandwidth of the DL/UL active bandwidth part and is no less than a bandwidth of the control resource set, if a time duration between an ending time of the PDCCH scheduling the PDSCH and/or the uplink channel and a start time of PDSCH reception and uplink channel transmission is no longer than (alternatively, less than) a first DL/UL delay value.

The UE receives the corresponding PDSCH and/or transmits the corresponding uplink channel either within the first DL/UL subband of the first DL/UL bandwidth or in a second DL/UL subband of a second DL/UL bandwidth, where the second DL/UL subband is included in the DL/UL active bandwidth part and where the second DL/UL bandwidth is no less than the first DL/UL bandwidth, if the time duration between the ending time of the PDCCH scheduling the PDSCH and/or the uplink channel and the start time of PDSCH reception and uplink channel transmission is longer than (alternatively, no less than) the first DL/UL delay value. The UE identifies which DL/UL subband (the first DL/UL subband vs the second DL/UL subband) it will receive and/or transmit based on frequency domain resource allocation information of the corresponding PDSCH or uplink channel.

In one implementation, the second DL/UL bandwidth is wider than the first DL/UL bandwidth. In one example, the second DL/UL subband is same as the DL/UL active bandwidth part. In another example, the second DL/UL subband includes the first DL/UL subband. In another implementation, the second DL/UL bandwidth is equal to the first DL/UL bandwidth, and the second DL/UL subband does not overlap in frequency with the first DL/UL subband at all or partially overlaps in frequency with the first DL/UL subband.

In one implementation, the reduced capability UE may receive information of the first DL/UL subband including the first DL/UL bandwidth, the second DL/UL subband including the second DL/UL bandwidth, and/or the first DL/UL delay value via higher layer signaling and/or via physical layer signaling. For example, the information includes starting (and/or ending) PRBs of the first/second subands. In another implementation, the first DL/UL subband including the first DL/UL bandwidth, the second DL/UL subband including the second DL/UL bandwidth, and/or the first DL/UL delay value may be predetermined, based on reported UE capability (e.g. bandwidth part switching delay, minimum operating bandwidth), the bandwidth of the DL/UL active bandwidth part, and/or the bandwidth of the control resource set. In one example, the first DL (and UL in TDD) subband is determined to be same as a frequency domain resource of the control resource set, and the first DL/UL bandwidth is same as the bandwidth of the control resource set. In another example, the first DL delay value is determined to be same as the reported bandwidth part switching delay or bandwidth retuning delay. The first DL/UL delay value may be defined in terms of the number of slots and/or the number of symbols for a subcarrier spacing of the active DL/UL bandwidth part. The UE expects to receive the PDSCH and/or transmit the PUSCH/PUCCH within the first DL/UL subband of the first DL/UL bandwidth on slot n+k, if receiving the associated PDCCH on slot n and if k determined based on the PDCCH is less than the first DL/UL delay value.

In other implementations, the first UL delay value for PUCCH is different from the first UL delay value for PUSCH. For example, the first UL delay value for PUCCH is determined based on PDSCH processing time corresponding to UE's PDSCH processing capability, a set of configured (or predefined) scheduling offset K₀ values (or the minimum scheduling offset value K₀ₘᵢₙ), and/or a set of configured (or predefined) HARQ-ACK feedback delay K₁ values. The first UL delay value for PUSCH is dependent on PUSCH processing time corresponding to UE's PUSCH processing capability and/or a set of configured (or predefined) scheduling offset K₂ values (or the minimum scheduling offset value K₂ₘᵢₙ. The first DL delay value is determined based on a set of configured (or predefined) scheduling offset K₀ values (or the minimum scheduling offset value K₀ₘᵢₙ).

In other implementations, reduced capability UEs are not expected to receive a PDSCH or transmit a PUSCH/PUCCH in a slot where a PDCCH scheduling the PDSCH or PUSCH/PUCCH is received.

In another embodiment, a UE receives indication of a first DL scheduling offset K₀ₘᵢₙ and a first UL scheduling offset K₂ₘᵢₙ for narrowband operation and receives indication of a second DL scheduling offset K₀ₘᵢₙ and a second UL scheduling offset K₂ₘᵢₙ for wideband operation. In one implementation, the second DL/UL scheduling offset values are larger than the first DL/UL scheduling offset values. The wideband operation is likely to be used for transmitting and/or receiving large size packets. Thus, more PDSCH and PUSCH processing time may be required and accordingly, a network entity (e.g. gNB) may configure the UE with different sets of scheduling DL/UL offset values for narrowband and wideband operations, respectively.

In other embodiments, a UE being operated with a narrow bandwidth within an active DL/UL bandwidth part is not expected to receive DL signals/channels or transmit UL signals/channels for a first duration right before a start of transmission or reception of a (dynamically or semi-statically) scheduled wideband signal/channel. For transmission timing of the scheduled wideband signal/channel, a timing advance value applied to the wideband signal/channel is taken into account. The UE being operated with a wide bandwidth within the active DL/UL bandwidth part (e.g. being operated with a bandwidth same as the bandwidth of the active DL/UL bandwidth part) is not expected to receive DL signals/channels or transmit UL signals/channels for a second duration right after expiration of a wideband operation timer. In one example, the value of a wideband operation timer is different for a transmission or reception of a semi-statically scheduled wideband signal and/or channel than for a dynamically scheduled wideband signal and/or channel. In one example, the value of a wideband operation timer is different for a transmission or reception of a first type of semi-statically scheduled wideband signal and/or channel and a second type of semi-statically scheduled wideband signal and/or channel (e.g., (e.g., DL semi-persistent scheduling, configured grant transmission, CSI feedback on PUCCH). In one example, the value of a wideband operation timer is different for a transmission of a wideband signal and/or channel and for a reception of a wideband signal and/or channel.

In one implementation, the first duration for a case that the UE switches from a DL (or UL) narrowband to a DL (or UL) wideband may be different from a case that the UE switches from an UL (or DL) narrowband to a DL (UL) wideband. Similarly, the second duration for a case that the UE switches from a DL (or UL) wideband to a DL (or UL) narrowband may be different from a case that the UE switches from an UL (or DL) wideband to a DL (UL) narrowband. In another implementation, the first duration is same as the second duration. In other implementations, the first duration, the second duration, and/or the wideband operation timer is predefined. Alternatively, the first duration, the second duration, and/or the wideband operation timer is indicated via higher-layer signaling, e.g. RRC or MAC-CE, or via physical-layer signaling, e.g. DCI.

In one example, the first duration is determined in terms of a first number of symbols, and the UE does not receive/transmit from a symbol starting no earlier than the first number of symbols before a starting symbol of the wideband signal/channel. In another example, the first duration is determined in terms of a first number of slots, and the UE does not receive/transmit from a slot starting no earlier than the first number of slots before a starting slot of the wideband signal/channel.

In one example, the second duration is determined in terms of a second number of symbols, and the UE does not receive/transmit from the first symbol right after expiration of the wideband operation timer to a symbol no later than the second number of symbols after the expiration of the wideband operation timer. In another example, the second duration is determined in terms of a second number of slots, and the UE does not receive/transmit from the first slot right after expiration of the wideband operation timer to a slot no later than the second number of slots after the expiration of the wideband operation timer.

Reduced capability UEs such as industrial wireless sensors, video surveillance, and wearables may need to be operated with the battery that should last from multiple days (e.g. wearables) to at least few years (e.g. industrial sensors). This disclosure presents methods to allow power-efficient PDDCH monitoring and yet to effectively exploit frequency diversity without increasing signaling overhead.

### Embodiment 1: Frequency Hopping of CORESET

A UE performs frequency hopping of a CORESET (possibly configured with a narrow bandwidth) within an active bandwidth part to exploit the frequency diversity and randomize the interference. Further, the UE determines a DL/UL subband associated with a frequency location of the CORESET, and receives/transmits DL/UL signal/channels within the DL/UL subband for narrowband operation.

### Embodiment 2: Opportunistic Wideband Operation within a Bandwidth Part

A UE monitors a narrowband CORESET and is operated within a subband associated with a frequency location of the narrowband CORESET until there is scheduled wideband DL signals/channels.
Once the UE starts to be operated with a wide bandwidth within an active DL/UL bandwidth part, the UE starts/restarts a wideband operation timer at every reception or transmission occasion of wideband signals/channels. Upon expiration of the wideband operation timer, the UE goes back to narrowband operation.
A UE receives indication of a first DL/UL scheduling offset values K₀ₘᵢₙ/K₂ₘᵢₙ for narrowband operation, and receives indication of a second DL/UL scheduling offset values K₀ₘᵢₙ/K₂ₘᵢₙ for wideband operation, where the second DL/UL scheduling offset values are larger than the first DL/UL scheduling offset values.

Operating a reduced capability UE with a narrow bandwidth by configuring and activating a narrowband bandwidth part may reduce power consumption. On the other hand, the narrowband bandwidth part may make it difficult to exploit frequency diversity and to randomize the interference. Configuring the reduced capability UE with multiple narrowband bandwidth parts and performing frequent switching of an active BWP may increase complexity, since each bandwidth part configuration should include a set of DL and UL RRC configuration parameters.

Frequency hopping of a narrowband CORESET and opportunistic wideband operation within a relatively wider bandwidth part can reduce RRC signaling overhead and UE complexity, and yet can reduce UE power consumption while flexibly handling various sizes of packets.

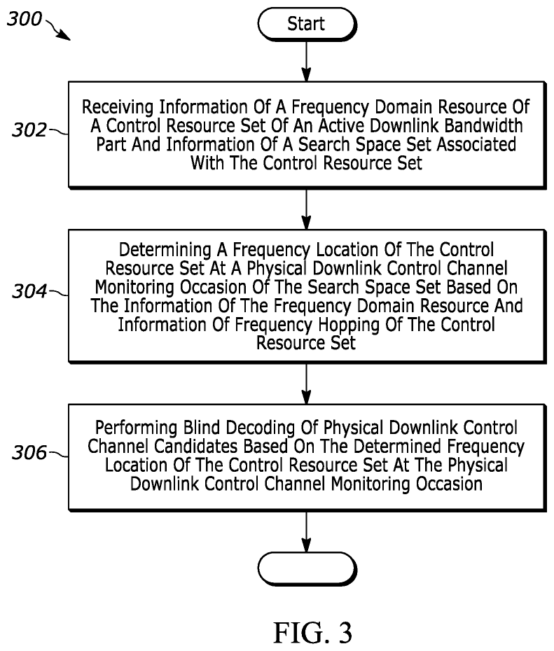

FIG. 3 illustrates a flow diagram 300 in a user equipment associated with the selective decoding of physical downlink control channel candidates based on a determined frequency location of the control resource set and determined information of frequency hopping. In accordance with at least one embodiment, the method can include receiving 302 information of a frequency domain resource of a control resource set of an active downlink bandwidth part and information of a search space set associated with the control resource set. A frequency location of the control resource set is determined 304 at a physical downlink control channel monitoring occasion of the search space set based on the information of the frequency domain resource and information of frequency hopping of the control resource set. Blind decoding of physical downlink control channel candidates is performed 306 based on the determined frequency location of the control resource set at the physical downlink control channel monitoring occasion.

In some instances, the method can further include receiving the information of frequency hopping of the control resource set.

In some instances, the information of frequency hopping of the control resource set can include at least one frequency offset value and a frequency hopping periodicity. In some of these instances, the frequency hopping periodicity can be a multiple of a physical downlink control channel monitoring periodicity.

In some instances, the method can further include determining a downlink subband within the active downlink bandwidth part, where the downlink subband is associated with the determined frequency location of the control resource set, and receiving at least one of a downlink signal and a downlink channel within the downlink subband. In some of these instances, the downlink subband can include at least the frequency location of the control resource set. Additionally and/or alternatively, the method can further include receiving scheduling information of at least one of a wideband signal and a wideband channel, where the at least one of the wideband signal and the wideband channel is not within the downlink subband but within the active downlink bandwidth part. A receiver bandwidth can then be retuned from a first bandwidth to a second bandwidth, where the second bandwidth is wider than the downlink subband and the first bandwidth. The at least one of the wideband signal and the wideband channel can be received according to the scheduling information, and a wideband operation timer can be activated at each occasion associated with each reception of the at least one of the wideband signal and the wideband channel. In one example, each occasion associated with each reception of the at least one of the wideband signal and the wideband channel is each reception occasion of the at least one of the wideband signal and the wideband channel. In another example, the occasion is a reception occasion of a physical downlink control channel that schedules the at least one of the wideband signal and the wideband channel. Further, in some instances, the method can further include retuning the receiver bandwidth from the second bandwidth to the first bandwidth upon expiry of the wideband operation timer.

In some instances, the method can further include determining an uplink subband of an uplink active bandwidth part, where the uplink subband is associated with the determined frequency location of the control resource set, and transmitting at least one of an uplink signal and an uplink channel within the uplink subband. In some instances, the method can further include receiving an indication of a first downlink scheduling offset value K₀ₘᵢₙ for operation with a first downlink bandwidth and an indication of a second downlink scheduling offset value K₀ₘᵢₙ for operation with a second downlink bandwidth, where the second downlink bandwidth is wider than the first downlink bandwidth and where the second downlink scheduling offset value is larger than the first downlink scheduling offset value.

In some instances, the method can further include receiving an indication of a first uplink scheduling offset value k₂ₘᵢₙ for operation with a first uplink bandwidth and an indication of a second uplink scheduling offset value K₂ₘᵢₙ for operation with a second uplink bandwidth, where the second uplink bandwidth is wider than the first uplink bandwidth and where the second uplink scheduling offset value is larger than the first uplink scheduling offset value.

In some instances, the user equipment can be configured with a plurality of control resource sets and a plurality of subbands within the active downlink bandwidth part, each subband associated with a particular control resource set of the plurality of control resource sets, and can perform subband switching among the plurality of subbands based on an established subband switching pattern.

In some instances, the user equipment can be configured with a plurality of downlink bandwidth parts and performs bandwidth part switching among the plurality of downlink bandwidth parts based on an established bandwidth part switching pattern.

In some instances, the user equipment can be a reduced capability user equipment.

In some instances, the user equipment monitoring a physical downlink control channel in the control resource set of the active downlink bandwidth part can be expected to receive a corresponding physical downlink shared channel confined within a first downlink subband of a first downlink bandwidth, where the first downlink subband can include the control resource set and where the first downlink bandwidth can be narrower than a bandwidth of the active downlink bandwidth part and is not less than a bandwidth of the control resource set, if a time duration between an ending time of the physical downlink control channel scheduling the physical downlink shared channel and a start time of physical downlink shared channel reception is no longer than a first downlink delay value. In some of these instances, the user equipment can receive the corresponding physical downlink shared channel either within the first downlink subband of the first downlink bandwidth or in a second downlink subband of a second downlink bandwidth based on downlink control information in the physical downlink control channel, if the time duration between the ending time of the physical downlink control channel scheduling the physical downlink shared channel and the start time of physical downlink shared channel reception is longer than the first downlink delay value.

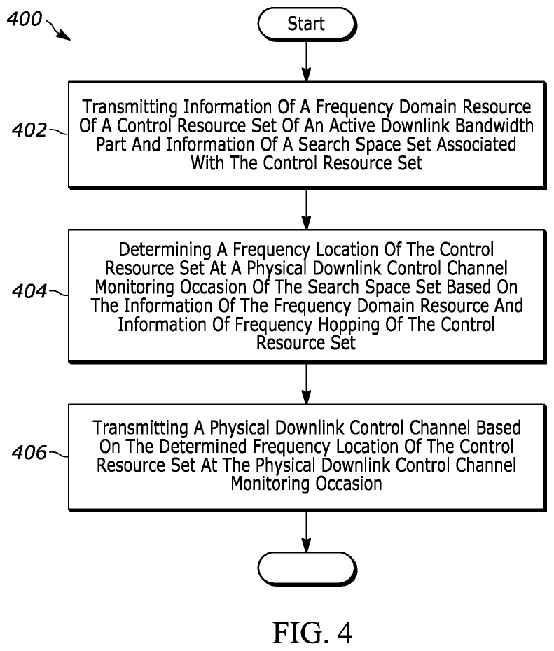

FIG. 4 illustrates a flow diagram 400 in a network entity associated with the selective transmission of physical downlink control channel candidates based on a determined frequency location of the control resource set and determined information of frequency hopping. In accordance with at least one embodiment, the method can include transmitting 402 information of a frequency domain resource of a control resource set of an active downlink bandwidth part and information of a search space set associated with the control resource set. A frequency location of the control resource set at a physical downlink control channel monitoring occasion of the search space set is determined 404, based on the information of the frequency domain resource and information of frequency hopping of the control resource set. A physical downlink control channel is transmitted 406, based on the determined frequency location of the control resource set at the physical downlink control channel monitoring occasion.

In accordance with another embodiment, the method can include determining a frequency domain resource of a control resource set of an active downlink bandwidth part and identifying each frequency location of the control resource set at each physical downlink control channel monitoring occasion of a search space set associated with the control resource set. Information of frequency hopping of the control resource set is determined based on the frequency domain resource of the control resource set and identified each frequency location of the control resource set at each physical downlink control channel monitoring occasion. Information of the frequency domain resource of the control resource set, information of the search space set, and information of frequency hopping of the control resource set are transmitted.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

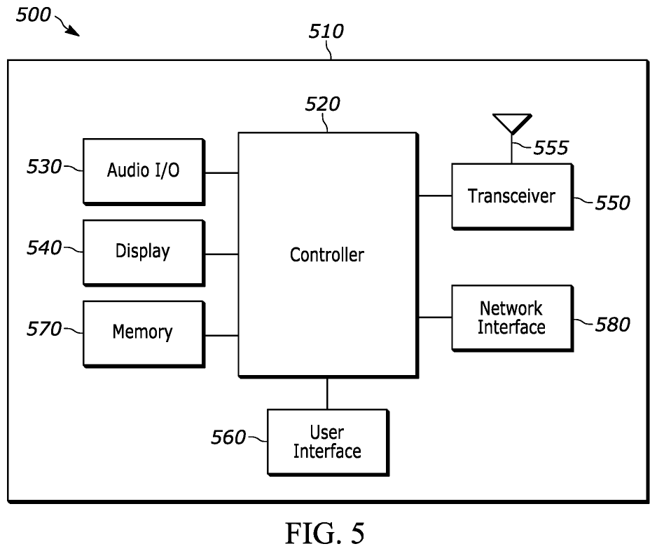

FIG. 5 is an example block diagram of an apparatus 500, such as the wireless communication device 110, according to a possible embodiment. The apparatus 500 can include a housing 510, a controller 520 within the housing 510, audio input and output circuitry 530 coupled to the controller 520, a display 540 coupled to the controller 520, a transceiver 550 coupled to the controller 520, an antenna 555 coupled to the transceiver 550, a user interface 560 coupled to the controller 520, a memory 570 coupled to the controller 520, and a network interface 580 coupled to the controller 520. The apparatus 500 can perform the methods described in all the embodiments.

The display 540 can be a viewfinder, a liquid crystal display (LCD), a light emitting diode (LED) display, a plasma display, a projection display, a touch screen, or any other device that displays information. The transceiver 550 can include a transmitter and/or a receiver. The audio input and output circuitry 530 can include a microphone, a speaker, a transducer, or any other audio input and output circuitry. The user interface 560 can include a keypad, a keyboard, buttons, a touch pad, a joystick, a touch screen display, another additional display, or any other device useful for providing an interface between a user and an electronic device. The network interface 580 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 570 can include a random access memory, a read only memory, an optical memory, a solid state memory, a flash memory, a removable memory, a hard drive, a cache, or any other memory that can be coupled to an apparatus.

The apparatus 500 or the controller 520 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 570 or elsewhere on the apparatus 500. The apparatus 500 or the controller 520 may also use hardware to implement disclosed operations. For example, the controller 520 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 520 may be any controller or processor device or devices capable of operating an apparatus and implementing the disclosed embodiments. Some or all of the additional elements of the apparatus 500 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

What is claimed is:

1. A method in a user equipment, the method comprising:
receiving information of a frequency domain resource of a control resource set of an active downlink bandwidth part and information of a search space set associated with the control resource set;
determining a frequency location of the control resource set at a physical downlink control channel monitoring occasion of the search space set based on the information of the frequency domain resource and information of frequency hopping of the control resource set; and
performing blind decoding of physical downlink control channel candidates based on the determined frequency location of the control resource set at the physical downlink control channel monitoring occasion.

2. The method according to claim 1, further receiving the information of frequency hopping of the control resource set.

3. The method according to claim 1, wherein the information of frequency hopping of the control resource set comprises at least one frequency offset value and a frequency hopping periodicity.

4. The method according to claim 3, wherein the frequency hopping periodicity is a multiple of a physical downlink control channel monitoring periodicity.

5. The method according to claim 1, further comprising:
determining a downlink subband within the active downlink bandwidth part, where the downlink subband is associated with the determined frequency location of the control resource set, and
receiving at least one of a downlink signal and a downlink channel within the downlink subband.

6. The method according to claim 5, wherein the downlink subband includes at least the frequency location of the control resource set.

7. The method according to claim 5, further comprising:
receiving scheduling information of at least one of a wideband signal and a wideband channel, where the at least one of the wideband signal and the wideband channel is not within the downlink subband but within the active downlink bandwidth part;
retuning a receiver bandwidth from a first bandwidth to a second bandwidth, where the second bandwidth is wider than the downlink subband and the first bandwidth;
receiving the at least one of the wideband signal and the wideband channel according to the scheduling information; and
activating a wideband operation timer at each occasion associated with each reception of the at least one of the wideband signal and the wideband channel.

8. The method according to claim 7, further comprising retuning the receiver bandwidth from the second bandwidth to the first bandwidth upon expiry of the wideband operation timer.

9. The method according to claim 1, further comprising:
determining an uplink subband of an uplink active bandwidth part, where the uplink subband is associated with the determined frequency location of the control resource set, and
transmitting at least one of an uplink signal and an uplink channel within the uplink subband.

10. The method according to claim 1, further comprising receiving an indication of a first downlink scheduling offset value K₀ₘᵢₙ for operation with a first downlink bandwidth and an indication of a second downlink scheduling offset value K₀ₘᵢₙ for operation with a second downlink bandwidth, where the second downlink bandwidth is wider than the first downlink bandwidth and where the second downlink scheduling offset value is larger than the first downlink scheduling offset value.

11. The method according to claim 1, further comprising receiving an indication of a first uplink scheduling offset value K₂ₘᵢₙ for operation with a first uplink bandwidth and an indication of a second uplink scheduling offset value K₂ₘᵢₙ for operation with a second uplink bandwidth, where the second uplink bandwidth is wider than the first uplink bandwidth and where the second uplink scheduling offset value is larger than the first uplink scheduling offset value.

12. The method according to claim 1, wherein the user equipment is configured with a plurality of control resource sets and a plurality of subbands within the active downlink bandwidth part, each subband associated with a particular control resource set of the plurality of control resource sets, and performs subband switching among the plurality of subbands based on an established subband switching pattern.

13. The method according to claim 1, wherein the user equipment is configured with a plurality of downlink bandwidth parts and performs bandwidth part switching among the plurality of downlink bandwidth parts based on an established bandwidth part switching pattern.

14. The method according to claim 1, wherein the user equipment is a reduced capability user equipment.

15. The method according to claim 1, wherein the user equipment monitoring a physical downlink control channel in the control resource set of the active downlink bandwidth part is expected to receive a corresponding physical downlink shared channel confined within a first downlink subband of a first downlink bandwidth, where the first downlink subband includes the control resource set and where the first downlink bandwidth is narrower than a bandwidth of the active downlink bandwidth part and is not less than a bandwidth of the control resource set, if a time duration between an ending time of the physical downlink control channel scheduling the physical downlink shared channel and a start time of physical downlink shared channel reception is no longer than a first downlink delay value.

16. The method according to claim 15, wherein the user equipment receives the corresponding physical downlink shared channel either within the first downlink subband of the first downlink bandwidth or in a second downlink subband of a second downlink bandwidth based on downlink control information in the physical downlink control channel, if the time duration between the ending time of the physical downlink control channel scheduling the physical downlink shared channel and the start time of physical downlink shared channel reception is longer than the first downlink delay value.

17. A user equipment for communicating within a network, the user equipment comprising:
a transceiver that receives information of a frequency domain resource of a control resource set of an active downlink bandwidth part and information of a search space set associated with the control resource set; and
a controller that determines a frequency location of the control resource set at a physical downlink control channel monitoring occasion of the search space set based on the information of the frequency domain resource and information of frequency hopping of the control resource set, and performs blind decoding of physical downlink control channel candidates based on the determined frequency location of the control resource set at the physical downlink control channel monitoring occasion.

18. The user equipment according to claim 17, wherein the information of frequency hopping of the control resource set comprises at least one frequency offset value and a frequency hopping periodicity.

19. The user equipment according to claim 17, wherein the controller further determines a downlink subband within the active downlink bandwidth part, where the downlink subband is associated with the determined frequency location of the control resource set, and
the transceiver further receives at least one of a downlink signal and a downlink channel within the downlink subband.

20. The user equipment according to claim 19, wherein the transceiver further receives scheduling information of at least one of a wideband signal and a wideband channel, where the at least one of the wideband signal and the wideband channel is not within the downlink subband but within the active downlink bandwidth part;
wherein a receiver bandwidth is retuned from a first bandwidth to a second bandwidth, where the second bandwidth is wider than the downlink subband and the first bandwidth, and the at least one of the wideband signal and the wideband channel is received according to the scheduling information; and
wherein a wideband operation timer is activated at each occasion associated with each reception of the at least one of the wideband signal and the wideband channel, and the receiver bandwidth is retuned from the second bandwidth to the first bandwidth upon expiry of the wideband operation timer.
